(19) United States
(12) Patent Application Publication
(10) Pub. No.: US 2012/0185479 A1
(43) Pub. Date: Jul. 19, 2012

(54) SYSTEM AND METHOD FOR ORGANIZING AND MANAGING CONTENT TO FACILITATE DECISION-MAKING

(75) Inventor: Clinton Douglas KORVER, Atherton, CA (US)

(73) Assignee: DecisionStreet, Inc., Atherton, CA (US)

(21) Appl. No.: 13/008,775

(22) Filed: Jan. 18, 2011

(51) Int. Cl. G06F 17/30

(52) U.S. Cl. 707/737; 707/E17.046

(57) ABSTRACT

A system is configured to organize content. The system may constitute a decision tool that provides a user with a decision template that enables the user to create a decision record that organizes aspects of a decision that the user considered, the user's reasoning with respect to these aspects in arriving at an ultimate outcome, and/or other information related to the decision. The decision template may include one or more fields into which the user may enter content manually, or the user may search for, and import content related to the decision into the template from, one or more content sources that include relevant content.

### FIELD OF THE INVENTION

The invention relates to the organization of content. More specifically, to the organization of content by a decision tool that can be provided to users over a network to facilitate the decision-making process of the users.

### BACKGROUND OF THE INVENTION

Systems for providing information to individuals faced with a decision are known. However, many such systems, particularly ones that harness the informational potential of the internet and rely on users to provide some or all of the information, may not enable a user to evaluate the credibility of information and/or its source. Further, such systems may maintain a vast amount of information that may not be organized in an intuitive and/or easily accessible manner. As such, a user submitting a request to this type of system may be answered with information that is either over-inclusive (and difficult to assimilate), or under-inclusive (leaving the user under-informed).

Some systems that provide information to users may include information provided by sponsors, or other informational groups. This information may be useful to users, but at the same time may be subject to abuse, as the sponsors or other informational groups may present information that casts them and/or their cause in a favorable light without being objective. Without some mechanism for discerning between credible and untrustworthy sources, users may not obtain opposing viewpoints or ideas, or may just dismiss all information from these types of sources, even the information that could be helpful to them.

Although systems that enable users to access information exist, typically, these systems do not provide a structure to users that can be used to more clearly analyze problems or decisions that users are facing. Without an overarching structure to their analysis, users may arrive at conclusions that may not be optimal for them.

### SUMMARY

One aspect of the invention relates to a decision tool that can be provided to a user over a network. The decision tool may provide a virtual decision record to the user that enables the user to organize and record aspects of the decision that the user considered, and the user's reasoning with respect to these aspects in arriving at an ultimate outcome. The decision record may be created using a decision template, into which the user may enter content manually, or the user may search for and/or import content related to the decision into the template from one or more content sources that include relevant content. In some instances, the decision tool may manage and organize a plurality of decision records associated with a plurality of users. The decision tool may organize the decision records into topical decision portals based on tags associated with the individual decision records. The tags may further be leveraged to refine searches of the decision portals and/or decision records conducted based on content and/or queries input by users. From the content sources included in a search result, a user may access content related to decisions by other users in order to facilitate their own decisions, in some cases using decisions records of other users as content sources for populating their own decision template.

In some embodiments of the invention, a user may create a new decision record. In creating a new decision record the user may provide a title for the decision record. The title may be descriptive of the decision that the user intends to resolve using the resources provided by the online decision tool. The user may also associate one or more tags with the decision. The tags may be words or phrases that are descriptive of the decision. In some instances, one or more tags may be automatically suggested to the user based on an entered decision title. The one or more tags may be suggested based on an analysis of tags associated with other decision records that have similar or related titles and/or content (e.g., decision records from a common decision portal with the created decision record). The title and/or the one or more tags that are selected by the user may be used to manage and/or organize the decision record in a system that manages a plurality of decision records associated with a plurality of users (e.g., as is discussed below).

When the user creates a new decision record, a blank (or substantially so) decision template associated with the new decision record may be provided to a user that presents the user with various generic categories of factors associated with a decision. The user may then populate these categories and/or other fields in the decision template with content that is relevant to their decision. In some embodiments, the factors may include, for example, factors related to the user's situation, factors related to the choices available to the user, factors related to the objectives of the user, other person's or parties that the user would like to include in the decision-making process, the user's evaluation of the various choices with respect to stated objectives, and/or other factors. The factors may be designed to enable the user to organize and record her analysis in deciding on a course of action.

In some instances, the user may populate the template associated with the decision record by manually entering appropriate content into the template. In some instances, the user may populate the template with content obtained from one or more content sources, or may reference content from one or more content sources. The content sources may include other decision records. The other decision records may include other decision records associated with the user herself and/or other decision records associated with third-party users. The content sources may further include content resources provided by other third-parties (e.g., sponsors, governmental agencies, consumer advocate groups, etc.) to users. The content sources may be presented to the user automatically based on the title of the decision record, the tags associated with the decision record, and/or content used by the user to populate the decision record (e.g., based on tags as described below). In some implementations, the user may perform a search for relevant content sources and/or content, or a search may be conducted automatically, and the user may use content and/or content source(s) culled from the search to populate the template associated with the decision record.

Populating the decision record with content obtained from a content source may include a “drag and drop” operation in which the user substantially copies content from the content source and imports the content to an appropriate position in the decision template. In some cases, the user may elect to use the content “as is.” However, in some instances, the user may import the copied content, and then may edit the imported content as desired.

As was mentioned above, in some embodiments of the invention, a plurality of decision records associated with a plurality of users may be managed. Managing the plurality of decision records may include topically organizing the decision records into a plurality of decision portals. The decision records may be organized based on tags associated with the decision records. The tags associated with a given decision record may include words and/or phrases found within the title and/or the content of the decision record. The tags may further include the keywords or phrases associated with the given decision record by the user. In some instances, users may be enabled to browse the decision records topically by accessing a given portal and then accessing decision records within the given portal. Portals that are topically related to the given portal may be displayed to the users to enable the users to access the related portals and the decision records included therein. In some implementations, a single decision record may be included within a plurality of decision portals. This may enable a user to access a decision record from a selected portal, and then access related portals from the selected decision record.

In some embodiments of the invention, the tags associated with a given decision record may be weighted (e.g., for purposes of topical association with one or more decision portals, for searching purposes, etc.). For example, the tags may include “active” tags, and “passive” tags that are not weighted as heavily as active tags. Active tags may include tags that are created based on words and/or phrases that are manually entered by a user into a decision record. Passive tags may include words and/or phrases that are otherwise associated with a decision record. For example, passive tags may include tags that are associated with content obtained by the user from an external content source. As another example, tags commonly associated with decision records in a decision portal that includes the given decision record may be added to the given decision record as passive tags. As yet another example, passive tags may be created based on searches performed by the user in trying to locate content relevant to the given decision record in the external content sources. Other types of passive tags are also contemplated. In some cases, the user that created the given decision record may validate, or accept, passive tags associated with the given decision record. Passive tags that are validated, or accepted, by the user may then become active tags.

According to various embodiments of the invention, the topical organization of decision records within decision portals may include determining a correlation metric representing the topical relevance of decision records to decision portals. The topical relevance of a given decision record to a decision portal may be determined based on the tags associated with the given decision record. For example, the topical relevance of the given decision record to the decision portal may be determined to reflect how frequently the tags associated with the given decision record occur in the other decision records within the decision portal.

In some embodiments of the invention, a credibility metric may be determined for the decision records to reflect the credibility of individual decision records and/or users. The credibility metric of a given decision record may be determined based on interactions of third-party users with the given decision record. For example, the more that the given decision record is viewed, referenced (e.g., content from the given record is referenced by a third party in one of their decision records), partially copied (e.g., content within the decision record is copied and used by a third party user in their own decision record), copied (e.g., all, or substantially all, of the content within the decision record is copied into a decision record being created by another user), or otherwise interacted with by other users, the higher a credibility metric of the given decision record may be. In some instances, the credibility metric of the given decision record may further reflect the credibility of the third parties that interact with the given decision record. For example, when the given decision record is viewed by a third party user with a relatively high credibility metric, the impact on the credibility metric of the given decision record may be greater than when the given decision record is viewed by a third party user with a relatively low credibility metric. The credibility metric of the given decision record may be impacted by the credibility metric of one or more information sources (e.g., other decision records) from which the user imports content into the given decision record (e.g., higher credibility sources increase the credibility metric of the given decision record). The credibility metric of an individual user may be an aggregation of the credibility metrics of decision records associated with the individual user.

As has been mentioned above, the decision tool may enable a user to search the decision records to find content. The decision tool may provide the user with a virtual search portal that enables the user to input a search query. Based on the search query, the decision tool may provide search results. The search results may include one or more decision portals, one or more decision records, and/or content culled from individual decision records. In determining the search results based on the search query, the decision tool may consider one or more of the correlation metrics, the credibility metrics, and/or match metrics of the decision portals and/or decision records. For example, one or more decision portals and one or more decision records that include tags that correspond to the search query may be identified. The identified decision records may be weighted within the search results according to correlation metrics to the identified decision portals. The identified decision records may further be weighted within the search by credibility metrics. The match metric of a given decision record may represent a correspondence between the given decision record and the search. For example, the match metric may reflect the strength of similarities between the given decision record and a decision record from which the search portal has been accessed (e.g., the decision record for which content is being searched). In some instances, the match metric may reflect the strength of similarities between the third party user that created the given decision record and the user that has input the search query (e.g., age, location, occupation, marital status, etc.).

In some embodiments of the invention, the one or more content sources that users are able to access content from may include content sources provided by one or more sponsors. The one or more sponsors may include individuals and/or companies that sell goods and/or services and that have expertise associated therewith. The one or more sponsors may be enabled to provide content to users for consideration (e.g., money). This consideration may be provided based on a number of users to which the sponsor is given access. The consideration may be provided in order to have a content source created by a sponsor be associated with one or more decision portals. The consideration may be provided based on search results that are returned to users including content from an information source created by a sponsor. In some instances, in order to help users identify sponsors that provide useful content, the credibility metrics of content sources created by the sponsors and/or the sponsors themselves may be determined (e.g., similarly to credibility metrics of users and/or decision records) and reported to the users. This may provide an incentive for sponsors to not simply provide content to users that is self serving and/or deceptive, as such actions may lead to a decreased credibility metric.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to organize content, in accordance with one or more embodiments of the invention.

FIG. 2 illustrates a decision template, in accordance with one or more embodiments of the invention.

FIG. 3 illustrates an information structure, in accordance with one or more embodiments of the invention.

FIG. 4 illustrates a method of creating and publishing a decision record, in accordance with one embodiment of the invention.

### DETAILED DESCRIPTION

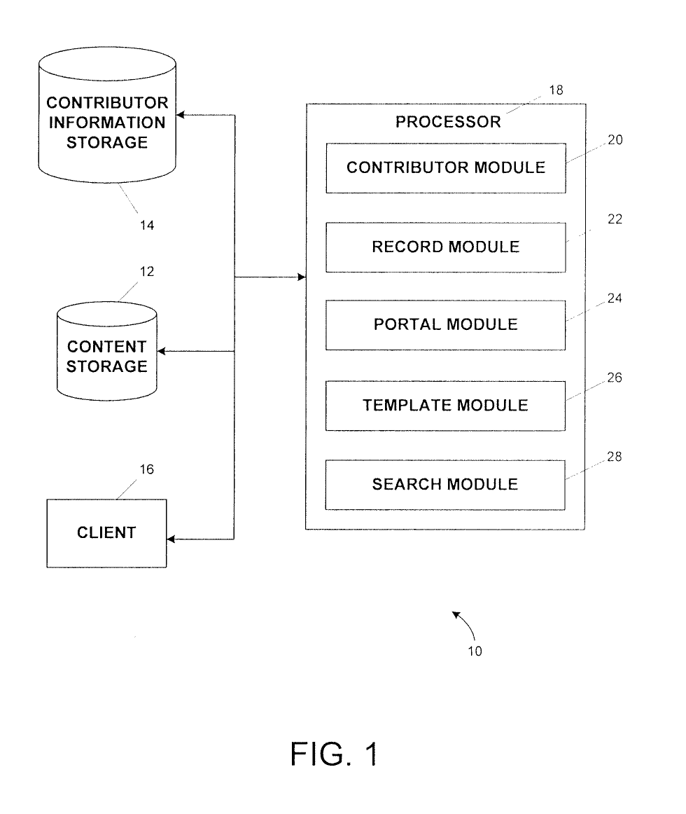

FIG. 1 illustrates a system 10 configured to organize content. In some embodiments, system 10 may constitute a decision tool that provides a user with a decision template that enables the user to create a decision record that organizes aspects of a decision that the user considered, the user's reasoning with respect to these aspects in arriving at an ultimate outcome, and/or other information related to the decision. The decision template may include one or more fields into which the user may enter content manually, or the user may search for, and import content related to the decision into the template from, one or more content sources that include relevant content. In some instances, system 10 may manage and organize a plurality of decision records associated with a plurality of users. System 10 may organize the decision records into topical decision portals based on tags associated with the individual decision records. The tags may further be leveraged to enable users to search the decision portals and/or decision records to access content related to decisions by other users. Users may access content related to decisions by other users in order to facilitate their own decisions, in some cases using decision records of other users as content sources for populating their own decision template. In some embodiments, system 10 may include one or more of content storage 12, contributor information storage 14, one or more clients 16, a processor 18, and/or other components.

System 10 may be implemented in a client/server architecture. This may provide the functionality attributed herein to one or more of the components of system 10 through one or more client computing platforms in communication with a server. The one or more client computing platforms may include, for example, one or more of a desktop computer, a laptop computer, a handheld computer, a Smartphone, a mobile telephone, a personal digital assistant, a tablet computer, and/or other client computing platforms. The client computing platforms may communicate with the server via a network (e.g., the Internet). The client computing platforms may communicate with the server via wired and/or wireless communication media. The client computing platforms may include user interfaces (e.g., electronic displays, keyboards, key pads, buttons, knobs, mouses, joysticks, speakers, and/or other interface devices) by which users may provide information and/or receive information from system 10.

The server may provide some or all of the functionality attributed herein to system 10 in a distributed manner for a plurality of users. The server may be realized in a hardware computer platform, and/or through virtual computing resources such as a virtual private network and/or a plurality of computing platforms operating as a cloud. In order to interface with the server and obtain access to the functionality provided by the server, the client computing platforms may execute one or more client applications. The one or more client applications may include a multi-purpose client application configured to interface with a plurality of servers serving different types of function and/or content (e.g., a web browser, and/or other applications). The one or more client applications may include a more specialized client application configured to interface primarily with the server(s) of system 10 (e.g., a dedicated Smartphone “app”, and/or other applications).

Content storage 12 may be configured to store content provided to content storage 12 by a plurality of users into non-transitory, electronic storage media. As has been mentioned above, the content stored within content storage 12 may be organized into separate decision records created by a plurality of users. The one or more electronic storage media of content storage 12 may include, for example, one or more optically readable media (e.g., optical disk(s), etc.), one or more magnetically readable media (e.g., magnetic disk(s), etc.), one or more solid stage storage devices (e.g., flash drive(s), etc.), and/or other electronically readable media. Although content storage 12 is illustrated in FIG. 1 as being a single entity, this is not intended to be limiting. In some instances, content storage 12 may include a plurality of devices, some of which may be located remotely from other ones of the devices.

Contributor information storage 14 may be configured to store information related to one or more entities that contribute content to system 10. For example, an entity that contributes content to system 10 may include a user (e.g., that creates a decision record), a group of users, a third-party that provides content relevant to decisions documented by one or more users in system 10 (e.g., a sponsoring corporation, a government agency, a consumer advocate group, etc.), and/or other entities. Contributor information storage 14 may include non-transitory, electronic storage media that store the information related to the entities that contribute content to system 10. The one or more electronic storage media may include, for example, one or more optically readable media (e.g., optical disk(s), etc.), one or more magnetically readable media (e.g., magnetic disk(s), etc.), one or more solid stage storage devices (e.g., flash drive(s), etc.), and/or other electronically readable media. Although content contributor information storage 14 is illustrated in FIG. 1 as being a single entity, this is not intended to be limiting. In some instances, contributor information storage 14 may include a plurality of devices, some of which may be located remotely from other ones of the devices.

Client 16 may be configured provide a user with access to system 10. In some implementations, client 16 may be formed by a computing platform executing one or more applications. Client 16 may be implemented in one of the client computing platforms discussed above.

Processor 18 is configured to manage information (e.g., content, contributor information, communication with client 16, etc.) within system 10. As such, processor 18 may include one or more of a digital processor, an analog processor, a digital circuit designed to process information, an analog circuit designed to process information, a state machine, and/or other mechanisms for electronically processing information. Processor 18 may be in operative communication with one or more of content storage 12, contributor information storage 14, client 16, and/or other components of system 10. The communication may be accomplished via a wireless link, a wired link, over a network, over a dedicated link, and/or otherwise accomplished. Although processor 18 is shown in FIG. 1 as a single entity, this is for illustrative purposes only. In some implementations, processor 18 may include a plurality of processing devices. These processing devices may be physically located within the same apparatus, or processor 18 may represent processing functionality of a plurality of devices operating in coordination.

As is shown in FIG. 1, in some embodiments, processor 18 includes contributor module 20, a record module 22, a portal module 24, a template module 26, a search module 28, and/or other modules. Modules 20, 22, 24, 26, and/or 28 may be implemented in software; hardware; firmware; some combination of software, hardware, and/or firmware; and/or otherwise implemented. It should be appreciated that although modules 20, 22, 24, 26, and/or 28 arc illustrated in FIG. 1 as being co-located within a single processing unit, in implementations in which processor 18 includes multiple processing units (e.g., the first processor disposed in the portable device and the second processor in at least periodic communication therewith), modules 20, 22, 24, 26, and/or 28 may be located remotely from the other modules. It should be apparent that the description of modules 20, 22, 24, 26, and/or 28 below is not intended to be limiting. In some embodiments, some or all of the functionality of one of the modules may be provided by another of the described modules, functionality of one module may be provided by two or more separate modules, additional modules may provide additional functionality, and/or other permutations of modules 20, 22, 24, 26, and/or 28 may be implementing without departing from the scope of this disclosure.

Contributor module 20 may be configured to manage information related to contributors of information to system 10. The contributors of information may include one or more users that input content for storage in content storage 12 (e.g., via client 16), one or more entities that provide content that users can reference and/or copy while using system 10, and/or other contributors of information to system 10. The information managed by contributor module 20 may include the information stored in contributor information storage 14.

With respect to a given user that accesses system 10 via client 16, the information managed by contributor module 20 may include a contributor profile associated with the given user. The contributor profile may include information that enables the user to identify herself (in some cases securely) to system 10. Such information may include one or more of a login, a username, a password, and/or other information that enables the given user to identify herself to system 10. The contributor profile may include demographic information related to the user. This demographic information may include one or more of an age, a gender, a race or ethnicity, an educational level, a location of residence, a socioeconomic status, an income, an employment status, a religion, a marital status, ownership (e.g., of a home, car, pet, etc.), one or more languages, and/or other information. The contributor profile may identify one or more decision records that have been created by the user. These may include completed decision records that have been made available to the public on system 10, and/or decision records that are currently under construction. The contributor profile may include a contributor credibility metric that represents the credibility of the user. The contributor credibility metric may be determined, for example, based on content credibility metrics that represent the credibility of the decision records that have been created by the user. In some implementations, various information included in the contributor profile may be public (e.g., available to other users on system 10) or private (e.g., not available to other users on system 10). The contributor profile may document which of included information is public and which is private.

Record module 22 may be configured to organize and/or manage some or all of the content stored in content storage 12. The content managed and/or organized by record module 22 may include content entered to system 10 by users in the form of records. Record module 22 may maintain the content in content storage 12 according to the created records. Record module 22 may be configured to associate tags with individual ones of the records. As used herein, the term “tag” may refer to a keyword or phrase associated with, or assigned to, a record that designates one or more topics to which the content of the record is pertinent. A tag may constitute meta-information related to an associated record. A tag may be associated with a record by record module 22 automatically based on an analysis of the record and/or based on a user selection or input. In some implementations, record module 22 may determine a content credibility metric that represents the credibility of the content in the record. The content credibility metric of a record may be determined based on one or more of a user that created the record, interaction with the record by users that did not create the record, a timeliness of the record (e.g., an amount of time since the record was last edited and/or interacted with), a completeness of the record, and/or other considerations.

Portal module 24 may be configured to organize content stored within content storage 12 into decision portals. A decision portal may constitute a set of content (e.g., group of decision records, content provided by third-parties, and/or other content) that is correlated together because it is pertinent to a common topic, or set of topics. The decision portals may include one or more portals that are created dynamically and automatically by portal module 24 and/or one or more portals that are created manually (e.g., by an administrator of system 10). The correlation of content with the decision portals may be based on tags associated with the content. For example, a given decision record stored in content storage may be correlated with one or more decision portals by portal module 24 by analyzing the tags associated with the given decision record and correlating the given decision record with the one or more decision portals that pertain to the tags associated with the given decision portal. A decision portal may be associated with one or more tags by portal module 24. The tags associated with the decision portal may be implemented by portal module 24 to correlate decision records with decision portals.

As was mentioned above, portal module 24 may be configured to dynamically create one or more decision portals. This may include analyzing the tags associated with the decision records and/or other content stored in content storage module 12, identifying a group of content (e.g., a group of decision record and/or other content) that is pertinent to one or more common topics based on common and/or topically related tags associated with the group of content, and creating a decision portal that pertains to the one or more common topics. Thereafter, decision records and/or other content that is newly created and/or input to system 10 may be correlated to the dynamically created decision portal if the new decision records and/or other content is associated with one or more tags that are topically related to the common topic(s) of the dynamically created decision portal.

Template module 26 may be configured to provide a template to a user (e.g., via client 16) that enables the user to create a decision record). Overall, the template may provide a structure for a decision record, into which the user may content that is specific to the decision that the user is representing in the decision record. The template may include one or more fields into which the user may input the content. The one or more fields may include one or more factor fields that correspond to factors that impact the decision represented by the decision record. The one or more factor fields may organized into one or more categories of factors within the template. In some implementations, template module 26 may enable the user to input content to the one or more fields by copying and/or referencing content already organized and/or managed by system 10 (e.g., content within previously created decision records). Template module 26 may, in some instances, automatically provide content to the template. For example, some or all of the demographic information included in the contributor profile that corresponds to the user may be automatically entered to the template.

Search module 28 may enable the user to search the content organized and/or managed by system 10 (e.g., decision records stored in content storage 12, third-party content, etc.). A search of the content may be performed in response to a search query entered by the user, or may be performed automatically while the user is creating a decision record by searching for content that is pertinent to the decision record being created. The results of a search performed by search module 28 may include one or more of previously created decision records, third-party content, previously created decision portals, and/or other content. The results of the search may be organized (e.g., ranked) based on one or more of credibility metrics of the content identified in the search that represent the credibility of the identified content, match metrics of the content identified in the search that represent similarities between the content in the decision record being created and the identified content, tags associated with one or both of the content identified in the search and/or content in the decision record being created, correlation metrics that represent the strength of correlation between decision records and decision portals identified by the search, and/or other considerations.

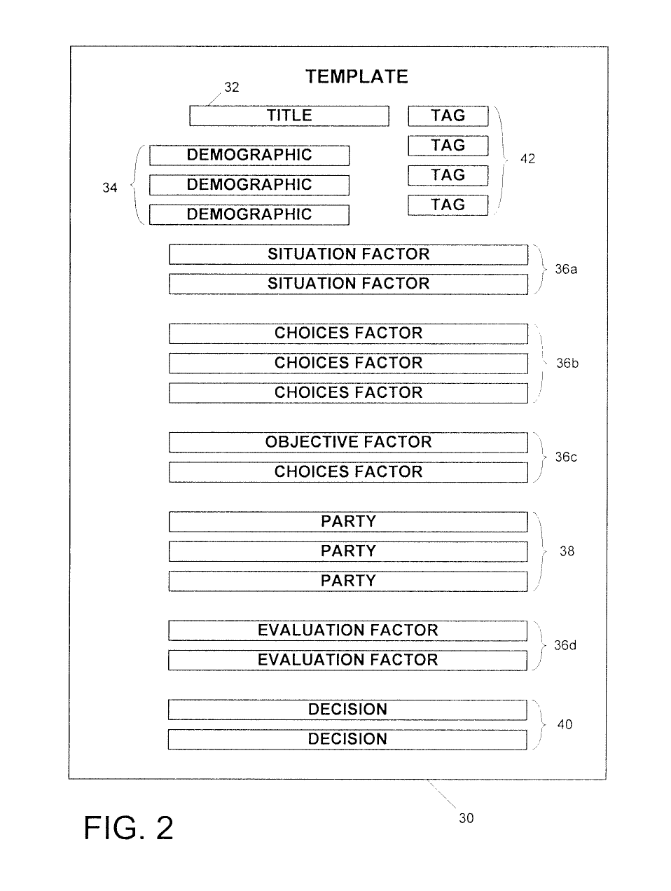

FIG. 2 illustrates a representation of a template 30 that enables a user to create a decision record. More specifically, template 30 may be provided to a user of a system that enables the user to create a decision record that organizes aspects of a decision that the user considered, the user's reasoning with respect to these aspects in arriving at an ultimate outcome, and/or other information related to the decision. For example, template 30 may be provided to a user of a system that is the same as or similar to system 10 (shown in FIG. 1 and described above). However, this should not be viewed as limiting, as template 30 may be used with a variety of other systems.

As can be seen in FIG. 2, template 30 includes a title field 32, one or more demographic information fields 34, one or more factor fields 36 (illustrated in FIG. 2 as factor fields 36a-36d), one or more party fields 38, one or more decision fields 40, one or more tag fields 42, and/or other fields. The user may be able to input content to fields 32, 34, 36, 38, 40, and/or 42. In some instances, one or both of a client the same as or similar to client 16 (shown in FIG. 1 and described above) and/or a template module the same as or similar to template module 26 (shown in FIG. 1 and described above) may enable the user to input content to fields 32, 34, 36, 38, 40, and/or 42. Inputting content to fields 32, 34, 36, 38, 40, and/or 42 may include manually inputting content to fields 32, 34, 36, 38, 40, and/or 42, and/or copying or referencing content from fields in other sources of content (e.g., other decision records, content sources provided by third parties, external resource such as websites and/or document, etc.).

Title field 32 may be configured to receive a title of the decision record being created from the user. The title may be descriptive of the decision being analyzed by the decision record and/or may denote one or more topics to which the decision being analyzed is pertinent. The title may be input to title field 32 by the user manually. Upon entry of an initial title, one or more alternative titles may be presented to the user, and the user may choose one of these alternative titles for entry into title field 32. For example, with respect to system 10 shown in FIG. 1, template module 26 may provide the initial title to search module 28, and search module 28 may search other decision records managed by system 10 for alternative titles that are related to the initial title. Search module 28 may identify the alternative titles by searching for matches between the initial title and titles and/or tags associated with the other records. Upon identifying other records that are associated with tags that match the initial title, search module 28 may rank the identified records (e.g., according to one or more of credibility metrics, match metrics, and/or other metrics) and the titles of the identified records may be presented to the user by template module 26 (e.g., via client 16) according to this ranking as the alternative titles. This may enable the user to select a title that best represents the decision being analyzed in the decision record being created.

Referring back to FIG. 2, demographic information fields 34 may be configured to receive demographic information related to the user creating the decision record via template 30. The demographic information may be input to demographic information fields 34 automatically and/or manually. For example, some or all of the demographic information may be automatically input to demographic information fields 34 from a contributor profile associated with the user (e.g., a profile managed by contributor module 20 and stored in contributor information storage 14, both of which are shown in FIG. 1 and discussed above). The demographic information input to demographic information fields 34 from the contributor profile may include demographic information that the user has previously designated as public. The user may be prompted (e.g., by the template module providing template 30) to include demographic information within the contributor profile that the user has previously designated as private, to enable the user to accept and/or reject the input of this private demographic information.

Factor fields 36 may be configured to receive content related to factors impacting the decision analyzed in the decision record being created. In some embodiments, factor fields 36 may be organized into one or more categories of factors impacting the decision. For example, factor fields 36 may include a set of factor fields 36a that are organized within a situation category. Factor fields 36a organized within the situation category may be configured to receive content from the user that specifies the situation of the user approaching the decision being analyzed. This content may include content related to the problem being addressed by the decision, the facts surrounding the problem being addressed by the decision, related decisions and/or problems that may impact or be impacted by the decision being analyzed, and/or other factors related to the situation of the user. In some instances, at least some of demographic fields 34 may be organized with factor fields 36a within the situation category, as some of demographic fields 34 may include content that defines the situation of the user.

As another example, factor fields 36 may include a set of factor fields 36b that are organized within a choices category. Factor fields 36b organized within the choices category may be configured to receive content from the user that specifies choices or options available to the user. This content may include content related to alternative options available to the user, information that is known about the available options, an identification of information that is not or cannot be known, and/or other content related to the choices available to the user making the decision.

As another example, factor fields 36 may include a set of factor fields 36c that are organized within an objectives category. Factor fields 36c organized within the objectives category may be configured to receive content related to the objectives addressed in making the decision. This content may include information related to a desired outcome of the user, parameters by which the outcome of the decision will be measured, an identification of tradeoffs the user would be willing to make in obtaining a specified outcome, and/or other information related to objectives of the user making the decision being analyzed by the decision record.

As yet another example, factor fields 36 may include a set of factor fields 36d that are organized within an evaluation category. Factor fields 36d organized within the evaluation category may be configured to receive content related to the evaluation of the choices available to the user (e.g., as specified in factor fields 36b). For example, this content may include information related to the reasoning of the user creating the decision record in choosing between the available choices.

It should be appreciated that the categories set forth above for factor fields 36 is not intended to be limiting. In some embodiments, additional categories for factor fields 36 may be implemented. In some embodiments, fewer categories, and/or other categories, for factor fields 36 may be implemented.

Party fields 38 may be configured to receive an identification of one or more parties that the user creating the decision record would like to consult for additional content, information, and/or analysis. This may include other users (e.g., friends or experts) and/or other third-parties (e.g., sponsors, government agencies or officials, consumer advocate groups, ect.). The identification of a party in one of party fields 38 may enable that party to contribute to the content in the decision record being created from template 30. For example, an identified party may able to directly add content to one or more fields in template 30, suggest content to the user creating the decision record (which the user may then accept for entry to template 30, or reject), edit content in one or more fields of template 30, and/or otherwise contribute to the content of the decision record. In some implementations, at any point during the analysis of the decision using the decision record being created, the user may add or delete a party from one of party fields 38. The deletion of a party from one of party fields 38 may prevent the deleted party from further contributing to the content in the decision record, and/or remove past contributions of the deleted party from the decision record.

Decision fields 40 may be configured to receive content from the user creating the decision record identifying the ultimate decision that was made. In some instances, this content may not only include an identification of the choices implemented, but may include one or more of the results of the decision made, the satisfaction of the user with the decision that was made, an identification of one or more alternatives that the user may prefer that she had implemented, and/or other information related to the ultimate decision that was made by the user.

Tag fields 42 may be configured to receive tags associated with the decision record being created. The tags associated with the decision record may include one or more tags that are manually associated with the decision record by the user (e.g., by manual entry to tag fields 42), associated with the decision record based on a selection by the user, automatically associated with the decision record, and/or otherwise associated with the decision record. In some implementations, one or more of tag fields 42 may be hidden, and one or more of tag fields 42 may be visible when viewing the decision record. For example, only tag fields 42 containing tags that are manually entered by the user and/or manually selected by the user may be visible when viewing the decision record, and tag fields containing tags that have been associated with the decision record automatically may be hidden. As another example, tag fields 42 including tags that are associated relatively closely with the decision record (e.g., are associated with content in the decision record a plurality of times, are associated with a decision portal correlated to the decision record, etc.) may be visible in the decision record, and tag fields 42 including tags associated with the decision record relatively loosely may be hidden. As another example, tag fields 42 including “active” tags (as discussed below) may be visible in the decision record, while tag fields including “passive” tags (as discussed below) may be hidden in the decision record.

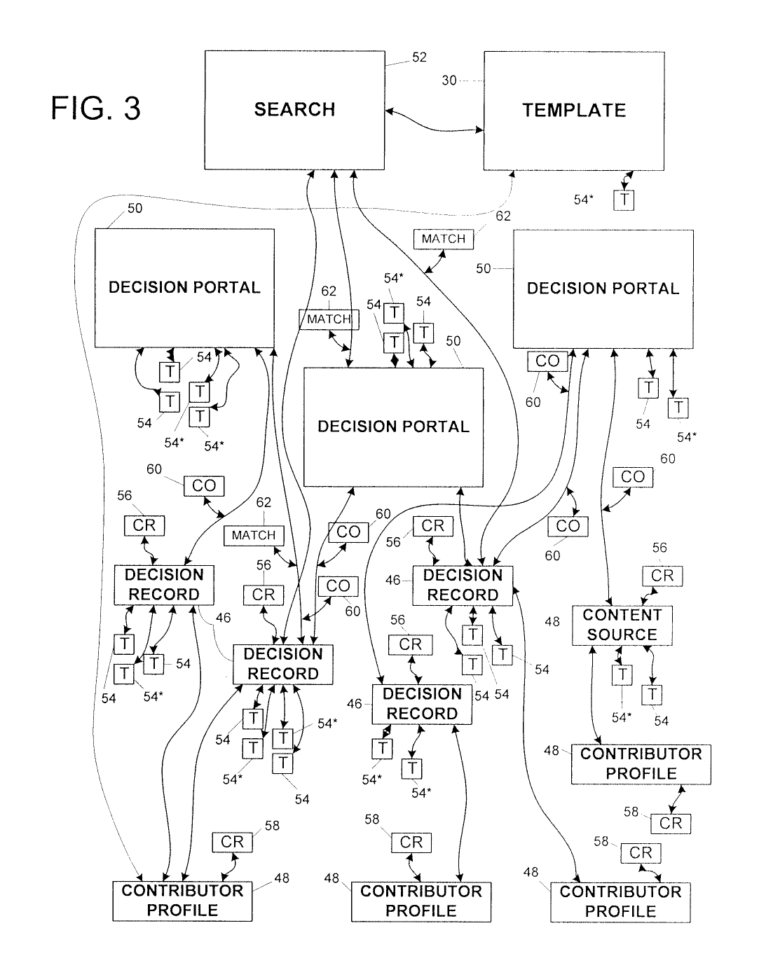

FIG. 3 illustrates a structure of information, such as content, contributor information, searches, tags, metrics and/or other information organized and/or managed by system 10 (illustrated in FIG. 1 and described above). It should be appreciated that the discussion of the structure of information illustrated in FIG. 3 with respect to system 10 is not intended to be limiting. Instead, system 10 may merely represent one of a plurality of possible systems that could be implemented to organize and/or manage information in accordance with this information structure. In some embodiments, the structure of information may include one or more of at least one decision record 44, at least one source of content 46 provided by a third-party, one or more contributor profiles 48, at least one decision portal 50, at least one search 52, and/or other information.

Decision records 44 may be organized and/or managed by record module 22 (shown in FIG. 1 and described above), or a similar record module, and may be stored in content storage 12 (shown in FIG. 1 and described above), or similar content storage. The content within decision records may be formatted in accordance with template 30 (shown in FIG. 2 and described above) or a similar template, to provide a structure to the content that facilitates analysis of a decision being analyzed via a given one of decision records 44. As has been mentioned above, individual decision records 44 may be associated with one or more tags 54, and/or a content credibility metric 56. FIG. 3 illustrates that a given decision record 44 may be associated with a contributor profile 48 that corresponds to the contributor (e.g., the user) that created the given decision record 44.

In some embodiments, tags 54 may be associated with a given decision record 44 by record module 22 (shown in FIG. 1 and described above), or a similar record module. Record module 22 may associate tags 54 with the given decision record 44 automatically and/or based on a manual selection or input of tags 54 by the user that created the given decision record 44. This was discussed briefly above with respect to FIG. 2. In some instances, tags 54 may include “active” tags 54 (indicated in FIG. 3 with an asterisk (*)) and/or “passive” tags 54. Active tags 54 may comprise tags with a stronger association to the given decision record 44 than passive tags 54. For example, active tags 54 may comprise tags 54 that have been associated with the given decision record 44 manually by the user, or tags 54 that have been otherwise affirmatively acknowledged by the user as being associate with the given decision record 44, whereas passive tags 54 may comprise tags that have been associated automatically with the given decision record 44 without the affirmative acknowledgement of the user.

By way of non-limiting example, as has been discussed above, some of the content within a given decision record 44 may include content that has been copied from another source of content, such as another one of decision records 44. Similarly, content within the given decision record 44 may reference content within another source of content. In such instances, tags associated with the other source(s) of content from which content has been copied and/or referenced may be associated with the given decision record 44 automatically (e.g., by record module 22). However, if this is done transparently to the user that has created the given decision record 44, this association may be considered weaker than active tags that have been manually associated with the given decision record 44 by the creating user. As such, the automatically associated tags that were initially associated only with the content that has been copied and or referenced in other content source(s) may be associated (e.g., by record module 22) as passive tags 54.

In some cases where content is imported (e.g., copied and/or referenced) to the given decision record 44 by the user from one or more other content sources, the content that is imported may be associated with tags 54 that are both passive and active in the other content source(s). Although tags 54 that are passive and active with respect to the other content source(s) may be associated with the given decision record 44 as passive tags 54, the association of these passive tags 54 with the given decision record 44 may denote different strengths of association amongst passive tags 54 (e.g., passive tags 54 that were active with respect to the other content source(s) may be associated more strongly than passive tags 54 that were also passive with respect to the other content source(s)).

As another example, a given decision record 44 may be correlated with one or more decision portals 50 (as will be discussed further below). Upon correlation with a decision portal 50 (e.g., by portal module 24, shown in FIG. 1 and described above), the given decision record 44 may be automatically associated with a set of tags 54 that correspond to the decision portal 50. In some instances, this association may be done automatically without manual input and/or selection by the user. These tags 54 may be associated with the given decision record 44 as passive tags 54.

Content credibility metrics 56 may represent the credibility of the content included within the individual decision records 44. As was mentioned above, content credibility metric 56 of a given one of decision records 44 may be determined (e.g., by record module 30 or a similar record module) based on one or more of a user that created the record, interaction with the record by users that did not create the record, a timeliness of the record (e.g., an amount of time since the record was last edited and/or interacted with), a thoroughness of the record (e.g., the amount of content included in the record), and/or other considerations. A content credibility metric 56 that corresponds to the given decision record 44 may be presented to a user that is viewing the given decision record 44 (e.g., via client 16 in FIG. 1) to enable the user to evaluate the credibility of the content included therein.

By way of illustration, the more that the given decision record 44 is viewed, referenced (e.g., content from the given record 44 is referenced by a third party in one of their decision records 44), partially copied (e.g., content within the decision record 44 is copied and used by a third party user in their own decision record 44), copied (e.g., all, or substantially all, of the content within the given decision record 44 is copied into a decision record 44 being created by another user), or otherwise interacted with by other users, the higher content credibility metric 56 of the given decision record 44 may be. Further, different types of interaction may contribute more to content credibility metric 56 than other interaction. For example, if the given decision record 44 is copied into a decision record 44 being created, the impact on credibility metric 56 may be greater than if the given decision record 44 is merely viewed.

In some instances, content credibility metric 56 of the given decision record 44 may further reflect the credibility of the third parties that interact with the given decision record. For example, if the given decision record 44 is viewed by a third party user with a relatively high contributor credibility metric, the impact on content credibility metric 56 of the given decision record 44 may be greater than if the given decision record 44 is viewed by a third party with a relatively low contributor credibility metric.

In some implementations, content credibility metric 56 of the given decision record 44 may be impacted by content credibility metrics 56 of one or more sources of content (e.g., other decision records 44) from which the user creating the given decision record 44 has imported content into the given decision record 44 (e.g., higher credibility sources increase content credibility metric 56 of the given decision record 44).

According to various embodiments, content credibility metric 56 of the given decision record 44 may be impacted by the extent to which the user that created the given decision record 44 has made content within the given decision record 44 public. This may include the extent to which content input by the user to one or more fields of the given decision record 44, such as demographic information fields 34, factor fields 36, party fields 38, and/or decision fields 40 described above with respect to FIG. 2, has been made public by the user. The more content that the user has made available to the public (e.g., other users on the system), the greater the positive impact on the content credibility metric 56 of the given decision record 44.

In some embodiments, sources of content 46 provided by third-parties may include content that is provided by a third party contributor (e.g., a sponsor, a government agency or agent, a consumer advocacy group, etc.) to facilitate the decision making process for users of the system providing the information structure shown in FIG. 3 (e.g., system 10). Although sources of content 46 may not have the same structure as decision records 44, sources of content 46 may be associated with tags 54, have content credibility metric 56, and/or be correlated with one or more decision portals 50 in a manner that is substantially the same as, or similar to, the manner in which these actions are taken with respect to decision records 44. Further, users creating decision records 44 may be able to reference, partially copy, copy, and/or otherwise interact with content from a source of content 46 in substantially the same manner as the users interact with decision records 44.

Contributor profiles 48 may include information related to contributors of content to the system, such as users that create decision records 56, third-party contributors that create content sources 46, and/or other contributors. As was discussed above with respect to system 10 of FIG. 1, such information may be stored in contributor information storage 14 and/or managed by contributor module 20. Referring back to FIG. 3, a given contributor profile 48 may store information that associates the contributor corresponding to the given contributor profile 48 with content that the contributor has created or is otherwise responsible for (e.g., the decision records 44 created by the contributor), a contributor credibility metric 58 that represents the credibility of the contributor, demographic information related to the contributor, and/or other information related to the contributor.

The contributor credibility metric 58 may be determined by contributor module 20, or a similar contributor module, and may be based on an aggregation of content credibility metrics 56 of content created by the contributor (e.g., a sum, an average, a weighted average, etc.). Thus, as the content credibility metrics 56 of decision records 44 that have been created by the contributor increase or decrease, the contributor credibility metric 58 stored in the contributor profile 48 that corresponds to the contributor will also increase or decrease. In some instances, contributor credibility metric 58 may further be a function of the amount of demographic information about the contributor that is designated in contributor profile 48 as being public (e.g., available to other users of the system).

As has been mentioned above in the description of portal module 24, decision portals 50 may constitute a set of content that is correlated together because it is pertinent to a common topic, or set of related topics. Decision portals 50 may be created dynamically and automatically (e.g., in the manner described above with respect to portal module 24), and/or manually. Decision portals 50 may individually be associated with sets of tags 54. The tags associated with a given decision portal 50 may include a primary set of tags 54 (which are denoted in FIG. 3 with an asterisk (*)) and a secondary set of tags 54. The primary tags 54 may include the tags 54 that most closely pertain to the common topic(s) of the given decision portal 50. In some instances, the primary tags 54 may be manually specified (e.g., by an administrator of the system), and/or identified automatically by portal module 24 (e.g., the tags 54 most often associated with records 44 and/or other content correlated to the decision portal), or a similar portal module. The secondary tags 54 may include a more comprehensive listing of the tags 54 associated with the decision records 44 and/or content sources 46 that are correlated with the given decision portal 50.

For example, the secondary tags 54 may include all of the tags 54 associated with any decision record 44 or content source 46 correlated with the given decision portal 50 that are not primary tags 54, while the primary tags 54 may include a more exclusive group of the tags 54 associated with decision records 44 or content sources 46 that are correlated with the given decision portal 50. In some instances, the primary tags 54 may include only the tags 54 that are associated with the decision records 44 or content sources 46 as active tags 54. In some instances, the primary tags 54 may include only the tags 54 that are associated with content correlated to the given decision portal 50 a predetermined number of times, only tags 54 that are associated with a predetermined number of decision records 44 and/or content sources 46 that are correlated with the given decision portal 50, only tags 54 that have been approved by an administrator, and/or some other more exclusive group of tags 54 that relate relatively closely to the common topic, or set of related topic(s), to which the given decision portal 50 pertains.

Decision records 44 and/or content sources 46 may be correlated with decision portals 50, for example, based on tags 54 associated with decision records 44 and/or content sources 46, and tags 54 associated with decision portals 50. Decision records 44 and/or content sources 46 associated with tags 54 that correspond to tags 54 associated with a given decision portal 50 may be correlated with the given decision portal 50. In some embodiments, a correlation metric 60 for a given decision record 44 and a given portal 50 may be determined (e.g., by portal module 24, or a similar portal module) that represents the strength of the correlation between tags 54 associated with the given decision record 44 and tags 54 associated with the given decision portal 50. If correlation metric 60 breaches a predetermined correlation threshold, then the given decision record 44 may be correlated with the given decision portal 50. The determination of correlation metric 60 may give added weight to a correlation between a decision record 44 and a decision portal 50 if a tag 54 that is associated with each of the decision record 44 and the decision portal 50 is an active tag 54 for the decision record. Similarly, a tag 54 that is a primary tag 54 for the decision portal 50 may more significantly impact the determination of correlation metric 60 than a tag 54 that is a secondary tag 54 for the decision portal 50.

As was mentioned above, if a given decision record 44 is correlated with a given decision portal 50, some or all of tags 54 associated with the given decision portal 50 may be associated with the given decision record 44 (e.g., as passive tags 54). In some implementations, the distinction between primary and secondary tags 54 may be used to determine which tags 54 associated with the given decision portal 50 may be associated with the given decision record 44. For example, only the primary tags 54 associated with the given decision portal 50 may be associated with the given decision record 44. As another example, all of the tags 54 associated with the given decision portal 50 may be associated with the given decision record 44, but the user creating (or that created) the given decision record 44 may be presented with the primary tags 54 of the given decision portal 50 as suggested active tags 54. The user may then choose to individually accept or reject the primary tags 54 as active tags 54 for the given decision record 44.

Search 52 may include an identification of content (e.g., decision records 44, content sources 46, etc.) that is relevant to a search query. In some embodiments, search 52 may be assembled by a search module that is similar to or the same as search module 28 (shown in FIG. 1 and described above). In some instances, the search query may include a string of text (e.g., keywords, phrases, etc.) entered into a search request by a user. In these instances, the assembled content may be determined based in part on a decision space currently being created (e.g., via template 30) by the user that enters the search query into the search request. In some instances, the search query may include template 30 being implemented by a user to create a decision record 44. In such instances, the search may include an identification of content that is determined to be relevant to the decision record 44 being created via template 30.

The content identified in search 52 may include one or more of at least one decision record 44, at least one content source 46, at least one decision portal 50, and/or other content. The content identified in the search may be may be organized (e.g., ranked) based on one or more of content credibility metric 56, similarities between tags 54 associated with content identified in search 52 and tags 54 associated with template 30, a match metric 62 that represents similarities between the decision record 44 being created by the user that initiated search 52 (e.g., via template 30) and/or similarities between a contributor profile 58 that corresponds to the user that initiated search 52 and contributor profiles 58 that correspond to the contributors that contributed the content identified in search 52, and/or other metrics. This may facilitate a presentation of search 52 to the user that initiated search 52 that tends to provide the most relevant content to the user first.

In some embodiments, match metric 62 is determined by the search module that conducts search 52. Match metric 62 may be determined based, at least in part, by comparing tags 54 associated with content identified in search 52 and tags 54 associated with the decision record being created by the user that initiated search 52. The determination of match metric 62 based on such tags 54 may weight the determination based on whether tags 54 associated with both the identified content and the decision record being created are active/primary tags 54, or passive/secondary tags 54. Match metric 62 may be determined based, at least in part, by comparing demographic information related to the user that initiated search 52 and demographic information associated with users that contributed the content that is identified in search 52. Content generated by contributors with similar demographic information to the user that initiated search 52 may be more relevant to the user that initiated search 52, and this may be reflected in match metric 62. The demographic information compared to determine match metric 62 may include information included within contributor profiles 48 and/or content included in decision records 44 and template 30.

In some embodiments, as the user implementing template 30 to create a decision record begins to enter content to template 30, search 52 may automatically be assembled and presented to the user. This may provide the user with content automatically as the user fills in template 30 by making content related to the decision record 44 being created available to the user throughout the process. The user may access the content identified in search 52, for example, to view, reference, partially copy, copy, or otherwise interact with the identified content in creating a decision record from template 30. As the user Creates the decision record 44 via template 30, search 52 may be continually refined to correspond to the content that the user is entering to template 30.

In some embodiments, search 52 may be assembled in response to a specific search query entered by a user. In such embodiments, match metric 62 may be determined between the content identified in search 52 and a decision record 44 that the user is currently creating via template 30. Further, if the user is not currently creating a decision record 44, match metric 62 may be determined based on demographic information included in a contributor profile 48 that corresponds to the querying user and demographic information included in contributor profiles 48 that correspond to contributors of the content identified in search 52.

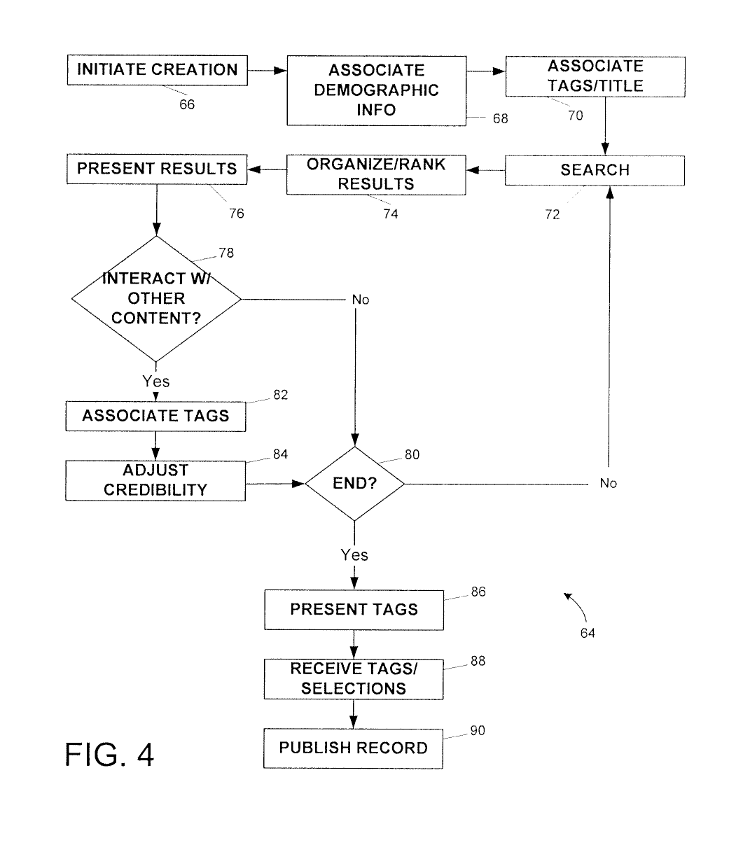

FIG. 4 illustrate a method 64 of creating a decision record. Although some of the operations of method 64 are discussed below with respect to the components of system 10 described above and illustrated in FIG. 1 and the information structure illustrated in FIG. 3 and described above, it should be appreciated that this is for illustrative purposes only, and that method 64 may be implemented with alternative components, systems, and/or information structures without departing from the scope of this disclosure. Further, the particular arrangement of the operations illustrated in FIG. 4 and described hereafter is not intended to be limiting. In some implementations, various ones of the operations could be performed in an order other than the one set forth, various ones of the operations may be combined with others and/or be omitted altogether, and/or various additional operations may be added without departing from the scope of the disclosure, as should be appreciated.

Method 64 may include an operation 66, at which the creation of a decision record may be initiated by a user. In some embodiments, the user may initiate the creation of the decision record via a client that is the same as or similar to client 16 (shown in FIG. 1 and described above). The initiation of the creation of the decision record may result in the presentation of a template to the user, into which the user may provide content to create the decision record. The template may be provided to the user by a template module that is similar to or the same as template module 26 (shown in FIG. 1 and described above).

At an operation 68, demographic information related to the user may be associated with the decision record. Associating demographic information with the decision record may include inputting demographic information to the template provided to the user at operation 66, and/or associating a contributor profile including demographic information with the decision template. Demographic information may be input to the template automatically (e.g., from the contributor profile), or may be input manually by the user.

At an operation 70, a title and/or one or more tags may be associated with the decision space. In some embodiments, the title and/or one or more tags may be associated with the decision space based on the entry of content (e.g., the title, and/or one or more key words or phrases) to the template that was provided to the user at operation 66. For example, the template may include a field configured to receive a title from the user. Based on the received title, one or more tags may be associated with the decision record being created by a record module that is similar to or the same as record module 22 (shown in FIG. 1 and described above).

At an operation 72, a search may be conducted to identify content related to the decision space being created. In some embodiments, operation 72 may be performed by a search module that is similar to or the same as search module 28 (shown in FIG. 1 and described above).

At an operation 74, content identified in the search conducted at operation 72 may be organized or ranked. In some instances, the content may be organized or ranked based on one or more of a content credibility metric (e.g., content credibility metric 56 illustrated in FIG. 3 and described above), a match metric (e.g., match metric 62 illustrated in FIG. 3 and described above), a correlation metric (e.g., correlation metric 60 illustrated in FIG. 3 and described above) and/or other metrics. In some embodiments, operation 74 may be performed by a search module that is similar to or the same as search module 28 (shown in FIG. 1 and described above).

At an operation 76, content identified at operation 72 and organized/ranked at operation 74 may be presented to the user. This presentation may, in some embodiments, be optional, and may be initiated by a command from the user. In other embodiments, the content may be automatically presented to the user.

At an operation 78, additional content related to the decision may be received into the template. The content may include content entered to one or more fields, such as the fields identified and described above with respect to template 30. In some instances, the content received into the template 78 from the user may include content that is copied from the content presented to the user at operation 76, and/or a reference to content presented to the user at operation 76. In such instances, method 64 may proceed to operation an 78. If no content has been copied or referenced to at operation 76, then method 64 may proceed to an operation 80.

At operation 82, tags previously associated with the content that was copied into the template, or tags previously associated with the content that was referenced in the template at operation 78 may be associated with the decision space being created. The tags may be associated with the decision record being created by a record module that is the same as or similar to record module 22 (shown in FIG. 1 and described above).

At operation 84, the content credibility metric corresponding to the content that was referenced and/or copied into the template at operation 78 is updated. For example, the content credibility metric corresponding to the content that was referenced and/or copied into the template at operation 78 may be increased based on the interaction that took place at operation 78. In some embodiments, operation 84 may be performed by a record module that is the same as or similar to record module 22 (shown in FIG. 1 and described above). From operation 84, method 64 may proceed to operation 80.

At operation 80, a determination may be made as to whether the user is done inputting content to the template. If the determination is made that the user is not done, then method 64 may return to operation 72 to search for content related to the decision record being created. The search performed this time at operation 72 may be augmented based on the content that was input to the template at operation 78. If the determination is made at operation 80 that the user is done inputting content to the template, method 64 may proceed to an operation 86.

At an operation 86, a set of suggested tags may be presented to the user. The presented tags may be determined, for example, based on tags that are associated with content identified at the search of operation 72. For instance, the most common tags associated with the content identified at operation 72, the tags associated with the content that is determined to be most relevant to the decision record being created at operation 74 (e.g., according to the organization/ranking of operation 74), and/or other tags associated with the content identified at operation 72 may be presented to the user.

At an operation 88, a designation of one or more tags to be associated with the decision record being created may be received from the user. This designation may include a selection from the tags presented to the user at operation 86 and/or manual entry of tags by the user. In some embodiments, operation 88 may be performed by a record module that is the same as or similar to record module 22 (shown in FIG. 1 and described above).

At an operation 90, the decision record being created may be published so that other user may view or otherwise interact with it. In publishing the decision record, a designation may be received from the user as to which portions of the content included in the decision record should be provided to the public, and which portions of the content included in the decision record should be maintained as private. Upon publishing the decision record, the decision record may further be refined and/or supplemented by the user.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to organize content, the system comprising:
content storage that stores content provided to the content storage by a plurality of users, wherein the content stored within the content storage is organized into separate records created by the plurality of users;
a record module that associates tags with individual records that designate topics to which the content therein is pertinent; and
a portal module that correlates the records with portals that pertain to topics based on the tags associated with the individual records, and wherein the portal module automatically creates portals by (i) analyzing the tags associated with the records, (ii) identifying a group of records that include content that is pertinent to a common topic based on the tags associated with the individual records in the group of records, and (iii) creating a portal that pertains to the common topic.

2. The system of claim 1, wherein the record module associates tags with individual records based on one or both of user selection of tags to be associated with individual records and/or an automatic analysis of the content included within individual records.

3. The system of claim 2, wherein the record module associates tags with a given record based on tags associated with other records that are correlated with a portal to which the given record is also correlated.

4. The system of claim 1, wherein the record module determines credibility metrics representing the credibility of the content in individual records.

5. The system of claim 4, wherein the credibility metric representing the credibility of the content in a given record is a function of one or more of a credibility metric that represents the credibility of a user that created the given record, interaction with the given record by users that did not create the given record, or a timeliness of the given record.

6. The system of claim 1, wherein the portal module determines a match metric that represents a strength of correlation between a given record and a portal with which the given record is correlated.

7. The system of claim 1, further comprising a template module that provides a template to a user that enables the user to create a record by entering content into one or more fields within the template.

8. The system of claim 7, wherein the template module enables the user to enter content into one or more fields within the template by copying content from one or more other records and pasting the content into the one or more fields.

9. The system of claim 8, wherein the record module associates the record created by the user entering content into one or more fields within the template with tags associated with the one or more other records from which the user copies and pastes content into the one or more fields.

10. A system configured to organize content, the system comprising:
content storage that stores content provided to the content storage by a plurality of users, wherein the content stored within the content storage is organized into separate records created by the plurality of users, and wherein the content stored within the records includes demographic information related the users that created the individual records;
a template module that provides a template to a user that enables the user to create a record for storage in the content storage by entering content into one or more fields within the template; and
a search module that identifies records stored in the content storage that are related to a record being created via the template module, wherein the search module identifies records that are related to the record being created based on (i) a comparison of content in individual ones of the stored records and the content in the record being created, and (ii) a comparison of demographic information related to the user creating the record being created and demographic information related to the users that created the stored records.

11. The system of claim 10, wherein the search module determines, for individual records that are related to the record being created, a match metric that represents similarities between the content in individual records and the content in the record being created and similarities between the demographic information related to the users that created the individual records and the demographic information related to the user creating the record being created.

12. The system of claim 11, wherein the individual records that are related to the record being created are ranked by the search module according to the match metrics for the individual records, and are presented to the user creating the record being created according to this ranking.

13. The system of claim 12, further comprising a record module that determines credibility metrics representing the credibility of the content in individual records, and wherein the ranking the individual records that are related to the record being created by the search module is further based on the credibility metrics of the individual records that are related to the record being created.

14. The system of claim 13, wherein the credibility metric representing the credibility of the content in a given record is determined by the record module as a function of one or more of a credibility metric that represents the credibility of a user that created the given record, interaction with the given record by users that did not create the given record, or a timeliness of the given record.

15. The system of claim 10, wherein one or more of the individual records that are identified by the search module as being related to the record being created are presented to the user creating the record being created, and wherein the template module enables the user to enter content to the record being created by copying information from one or more of the records presented.

16. The system of claim 15, further comprising a record module that determines sets of tags associated with individual records that designate topics to which the content therein is pertinent, wherein the record module determines the tags associated with content copied into the record being created from other records, and associates these tags with the record being created.

17. A system that provides support for a user confronted with a decision, the user interface comprising:
a template module that provides a template to the user that enables the user to create a record related to the decision by entering content into the template, wherein the template comprises:
a title field that enables the user to enter a title for the record;
factor fields that correspond to a plurality of categories of factors, wherein the user factor fields enable the user to enter one or more factors for each of the plurality of categories of factors; and
demographic information fields that enable the user to input demographic information;
content storage that stores a plurality of records created by other users;
a record module that associates sets of tags with individual records stored in the content storage, wherein the tags designate topics to which the content in the individual records is pertinent, and that associates one or more tags with the record being created by the user via the template module; and
a search module that identifies records stored in the content storage that are relevant to the record being created based on the tags associated with individual ones of the records stored in the content storage and the record being created, wherein the template module enables the user to enter content to the template by copying content in one or more of the records identified by the search module.

18. The system of claim 17, wherein categories of factors in the template comprise a situation category having factor fields that receive content from the user related to the situation of the user, and a choices category having factor fields that receive content from the user related to the choices available to the user.

19. The system of claim 18, wherein the categories of factors in the template further comprise an objectives category having factor fields that receive content from the user related to the objectives of the user.

20. The system of claim 17, wherein the template further comprises one or more party fields that enables the user to identify one or more parties from whom the users will accept information related to the decision.

21. The system of claim 20, wherein the identification of a party in the one or more party fields enables the identified party to enter content to the record being created.

22. The system of claim 17, wherein the template further comprises one or more decision fields that receive an identification of the-final decision reached by the user.
